(19) United States
(12) Patent Application Publication
(10) Pub. No.: US 2025/0113182 A1
(43) Pub. Date: Apr. 3, 2025

(54) Method and System for Providing Bluetooth Encryption Data for a Network Component

(71) Applicant: Bayerische Motoren Werke Aktiengesellschaft, Muenchen (DE)

(72) Inventors: Sven Hofmann, Muenchen (DE); Stefan Diewald, Moosburg a. d. Isar (DE); Thorsten Knott, Tuntenhausen (DE)

(21) Appl. No.: 18/729,781

(22) PCT Filed: Sep. 28, 2022
(86) PCT No.: PCT/EP2022/076910

§ 371 Date: Jul. 17, 2024

(30) Foreign Application Priority Data
Jan. 31, 2022 (DE) 10 2022 102 156.4

(51) Int. Cl. H04W 12/03

(52) U.S. Cl. CPC H04W 12/03

(57) ABSTRACT

A vehicle is disclosed herein having a network device for providing Bluetooth encryption data. The network device comprises a controller and one or more interfaces for communication with a user terminal. The controller is configured to receive information for generating Bluetooth encryption data for establishing an encrypted Bluetooth connection between the vehicle and a user terminal based on the received information. The controller is further configured to generate the Bluetooth encryption data, and synchronize the Bluetooth encryption data between the vehicle and the user terminal.

### CROSS-REFERENCE TO RELATED APPLICATIONS

The present application is the U.S. national phase of PCT Application PCT/EP2022/076910 filed on Sep. 28, 2022, which claims priority of German patent application No. 10 2022 102 156.4 filed on Jan. 31, 2022, the entire contents of which are incorporated herein by reference.

### FIELD

The present disclosure relates to the field of motor vehicles and a method and system for a network component for providing Bluetooth encryption data for a vehicle.

### BACKGROUND

The use of digital keys allows a user of a vehicle to open it very easily. In particular, by means of Smart Access each user device can be configured to act as a digital key for a vehicle. For this purpose, for the configuration of a new user terminal, a digital key, also called data key, can be forwarded to a user terminal, e.g. from the vehicle. Thus, the user terminal can be configured/authenticated in such a way that access to, for example opening, starting, etc. of the vehicle is enabled via radio, e.g. Bluetooth or Ultra Wideband Technology (UWB). However, to open/start the vehicle, the user terminal must first establish a connection to the vehicle, e.g. via Bluetooth, which requires the initial establishment of a Bluetooth connection, for example via Bluetooth pairing. The Bluetooth pairing process can generate an undesirably high data volume or exchange. In addition, the Bluetooth pairing process can take an inconveniently long time for a user, which can detract from the user experience. In addition, for each Bluetooth-enabled user terminal that wants to connect to the vehicle the vehicle must first check whether there is authorization for the respective user terminal. This can increase the vehicle's energy consumption unnecessarily.

There is therefore a need to provide a means for generating Bluetooth encryption data and synchronizing said data between a first user terminal and a second user terminal.

### SUMMARY

Exemplary embodiments disclosed herein are based on the concept that the establishment of a Bluetooth connection can be improved by generating Bluetooth encryption data and synchronizing this data between a first user terminal and a second user terminal. For example, this can improve the initial establishment of a Bluetooth connection, e.g., it can improve a Bluetooth pairing operation.

Exemplary embodiments relate to a method for a network component for providing Bluetooth encryption data. The method comprises the step of obtaining information for generating Bluetooth encryption data for establishing an encrypted Bluetooth connection n between a first user terminal and a second user terminal based on the received information. The method further comprises a step of generating the encryption Bluetooth data and synchronizing the Bluetooth encryption data between the first user terminal and the second user terminal. This allows the first user terminal to establish a simplified form of Bluetooth connection to the second user terminal. In particular, the Bluetooth encryption data may comprise all the necessary parameters for establishing a Bluetooth connection, so that no further information exchange between the first user terminal and the second user terminal may be necessary for establishing a Bluetooth connection. In particular, an initial establishment of a Bluetooth connection, which can at least partially occur unencrypted, can be improved by a prior exchange of Bluetooth encryption data. In particular, a Bluetooth pairing can carried out directly based on the Bluetooth encryption data. In particular, this can reduce information exchange based on out-of-band and/or can take place at a different time. This can increase security, improve Bluetooth connection setup and/or reduce data transfer.

In some exemplary embodiments, the received information can comprise an identification for at least the first user device or the second user device. In particular, this can be used to assign/detect an authenticated user terminal, for example, a new user terminal to be added, which has obtained a data key.

In one exemplary embodiment, the network component may be an administrative platform or an additional user terminal. For example, an administrative platform can manage access to a vehicle and provide Bluetooth encryption data to at least one user terminal and the vehicle for this purpose. For example, one user terminal might manage data keys for opening the vehicle, which can be forwarded to another user terminal so that this one can gain access to the vehicle.

In one exemplary embodiment, the first user terminal can be a vehicle. In particular, the establishment of a Bluetooth connection between a vehicle and a user terminal, which can be implemented in particular as a digital key, can be simplified.

In one exemplary embodiment, the Bluetooth encryption data can be generated in the vehicle. This enables the vehicle in particular to improve the establishment of a Bluetooth connection between the vehicle and a user terminal without requiring any other infrastructure, such as an external administrative platform.

In one exemplary embodiment, the Bluetooth encryption data can comprise information about at least one parameter required for a Bluetooth pairing. In particular, a Bluetooth pairing between the first user terminal and the second user terminal can be thereby improved.

In one exemplary embodiment, the method may further comprise a step of encrypting the Bluetooth encryption data for synchronization. This ensures that the Bluetooth encryption data cannot be read by a third entity.

Exemplary embodiments also provide a computer program for implementing a method described herein, when the computer program is executed on a computer, a processor or a programmable hardware component (any of which may be referred to herein as a “control module” or a “controller”).

A further exemplary embodiment is a device for a network component for providing Bluetooth encryption data. The device comprises one or more interfaces for communication with other communication devices (e.g., the first user terminal and/or the second user terminal) and a control module which is designed for carrying out at least one of the methods described herein. In addition, exemplary embodiments provide a vehicle having a device as described herein.

### BRIEF DESCRIPTION OF THE DRAWINGS

Exemplary embodiments will be explained below with reference to the accompanying drawings:

FIG. 1 shows a schematic representation of one example of a method for providing encryption data;

FIG. 2 shows a block diagram of an exemplary embodiment of a device for a network component; and

FIGS. 3a and FIG. 3b show two schematic diagrams illustrating the generation and exchange of Bluetooth encryption data.

### DESCRIPTION

Various exemplary embodiments will now be described in more detail with reference to the accompanying drawings, in which several exemplary embodiments are shown. In the figures, the thickness dimensions of lines, layers and/or regions are shown exaggerated for the sake of clarity.

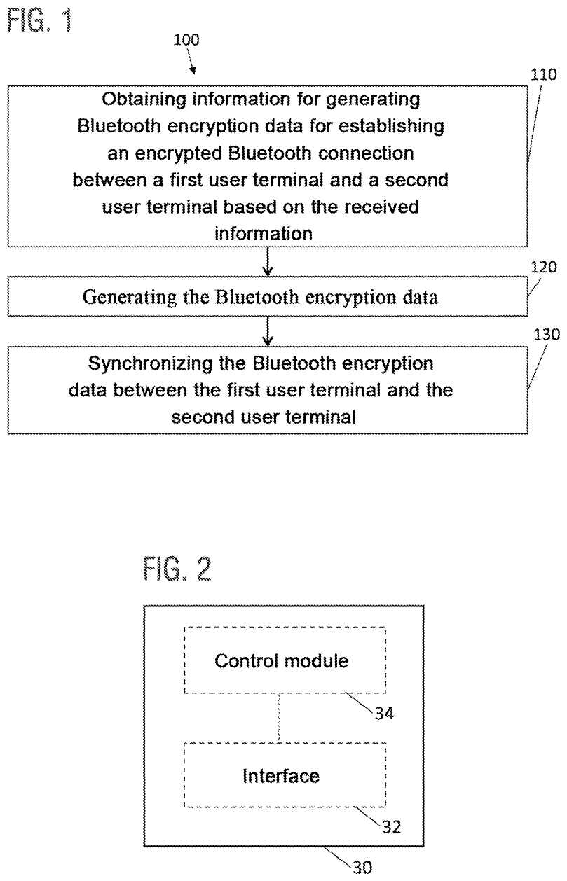

FIG. 1 shows a schematic illustration of a method 100 for providing Bluetooth encryption data. The method 100 comprises the step of obtaining 110 information for generating Bluetooth encryption data for establishing an encrypted Bluetooth connection between a first user terminal and a second user terminal based on the received information. The method 100 further comprises a step of generating 120 the Bluetooth encryption data and synchronizing 130 the Bluetooth encryption data between the first user terminal and the second user terminal. In particular, the term Bluetooth can include all types of Bluetooth protocols, such as Bluetooth Low Energy.

The first user terminal (UE) and/or the second user terminal may generally be a device capable of communicating wirelessly. In particular, either the first UE or the second UE is a mobile UE, e.g. a UE which is suitable for being carried by a user. For example, the first or second UE can be a user terminal (UT) or user equipment (UE) in the sense of the respective communication standards used for mobile communication. The first or second UE may be, for example, a mobile phone, such as a smartphone, or another type of mobile communication device, such as a smartwatch, a laptop, a tablet computer, a pair of autonomous augmented reality glasses, etc. In particular, the first or second UE can be a digital key in accordance with the Car Connectivity Consortium (CCC) standard. For example, the CCC-TS-101 Digital Key Technical Specification Release 3, Version 1.0.0 standard can be used for communication between the UE and the vehicle, for example as described in “Bluetooth LE Pairing & Encryption Setup Procedure”, p. 347ff. In particular, the generation of Bluetooth encryption data, i.e. the step of generating 120, can replace a known standard. For example, the generation of Bluetooth encryption data described in Section 18.4.9. “Derivation of System Keys”, p. 290, can be replaced by the generation 120 of the network component. Furthermore, the exchange of information (data) between different user terminals can be extended, for example as described in Table 19-74: 7F49 Template, p. 346. In particular, the exchange can be extended by synchronizing 130 the network components. In addition, in the case that the network component is a backend, for example to a vehicle, an extension can be performed, for example that in Section 17.7.1.3 trackKeyResponse, p. 246, for the synchronization 130.

In particular, the first UE can communicate with the second UE using a wireless personal area network (WPAN), e.g. Bluetooth, etc. In particular, the first UE can communicate with the second UE in accordance with IEEE 802.15.1-2005—IEEE Standard for Information Technology. The step of synchronizing 130 can thus simplify a Bluetooth pairing and/or a password-authenticated key agreement (PAKE-)authentication.

The step of obtaining 110 the information may comprise in particular a determining or receiving step. Depending on the particular function of the network component, the information obtained may differ. For example, the network component can be the first UE or the second UE. Alternatively, the network component can be an additional UE. Alternatively, the network component can be an administrative platform.

For example, the network component may be an additional UE, e.g. a master device, which manages data keys for access to a vehicle, for example, the first UE. In particular, a second UE can be authenticated by a data key to establish a connection to the first UE. The additional UE can send a data key to the second UE and, for example, obtain 110 an item of received information from the second UE. The additional UE can also generate the Bluetooth encryption data 120 and synchronize 130 the data between the first UE and the second UE. The step of synchronizing 130 can then comprise or consist of, for example, sending the Bluetooth encryption data from the additional UE to the first UE and the second UE. Alternatively, the additional UE can be replaced by an administrative platform, in particular for the management of a plurality of vehicles.

For example, the network component can be the first UE, which is comprised, for example, by a vehicle. The vehicle or the first UE can obtain 110 information from the second UE, which comprises a request to use the vehicle, for example via an intermediate network component, such as a server. The vehicle or the first UE can then generate 120 Bluetooth encryption data and synchronize it 130. The step of synchronizing 130 can include or consist of sending the Bluetooth encryption data from the first UE to the second UE. Alternatively, the second UE, for example a smartphone, can generate 120 the Bluetooth encryption data and synchronize it 130, in particular by sending it to the vehicle or the first UE.

The step of generating 120 the Bluetooth encryption data may in particular comprise generating all necessary parameters for establishing a Bluetooth connection, for example required parameters from the PAKE for establishing an encrypted connection, parameters from the Bluetooth pairing, etc. By generating 120 the Bluetooth encryption data by means of the network component, this data can be generated in particular on only one electronic device. This eliminates, among other things, the generation and transmission of some parameters, which alone are not sufficient to establish a Bluetooth connection, by the first UE or the second UE. Furthermore, a symmetrical generation of Bluetooth encryption data using the first UE and the second UE can be omitted. By obtaining 110 the information and generating 120 the Bluetooth encryption data by the network component alone, the exchange of data between the first UE and the second UE can be reduced. In addition, the establishment of a Bluetooth connection can be simplified and/or improved.

The step of synchronizing 130 can enable a Bluetooth connection to be established between the first UE and the second UE, in particular without the need for out-of-band communication, immediately before a Bluetooth connection is initially established. For example, an initial establishment of a Bluetooth connection can be started without a prior exchange of information via out-of-band between the first UE and the second UE. In particular, this can improve Bluetooth pairing, reduce data transfer and/or improve a user's experience. For example, out-of-band communication can occur in advance, which means that a user no longer needs to take any further action to establish an initial Bluetooth connection. For example, this avoids the need to enter a PIN for the Bluetooth connection to be established. In addition, a Bluetooth connection can be established between the first UE and the second UE without each UE generating its own parameters and exchanging them with the other UE.

By means of the synchronizing step 130, therefore, the determination of the necessary parameters by the respective UE can be avoided, in particular when establishing a Bluetooth connection between the first UE and the second UE for the first time. In particular, the generation of a subset of parameters for establishing a Bluetooth connection on both UEs, which requires an exchange of subsets of parameters between the two UEs, can be replaced by the synchronizing step 130. In particular, a derivation symmetrical of necessary parameters by both UEs based on the PAKE can be avoided.

In addition, by using the network component that generates 120 and synchronizes 130 the Bluetooth encryption data, recognition of the second UE by the first UE can be improved. For example, in an alternative system, an additional UE can provide a data key for the first UE to a second UE, for example, but not all the necessary parameters for a key exchange, i.e. in order to allow the second UE also to access the first UE. Instead, to establish a Bluetooth connection for the first time to a second UE that has obtained a data key, the first UE must deactivate a security protocol in order to establish a connection. By generating 120 and synchronizing 130 the Bluetooth encryption data, the deactivation of the security protocol can be avoided.

Furthermore, in an alternative system in which necessary parameters are generated during the initial establishment of a Bluetooth connection, the Bluetooth encryption data cannot be generated by an external entity, for example an administrative platform, since this is not involved in the initial establishment of the Bluetooth connection. By the steps of generating 120 and synchronizing 130, the Bluetooth encryption data can advantageously be generated and shared by an external entity, the network component, for example an administrative platform.

In one exemplary embodiment, the received information can comprise an identification for at least the first user device or the second user device. In particular, the information may include an identification for the first user device and/or the second user terminal. For example, the network component may be the first UE, for example comprised by a vehicle, and obtain information about an identification of the second UE. As a result, the vehicle can only leave an energy-saving mode after detection of a previously defined UE. In particular, an attempt by an unknown UE, which has no authentication for the vehicle, to establish a Bluetooth connection cannot lead to the vehicle terminating the energy saving mode. The vehicle, i.e. the first UE, can thus terminate the energy saving mode in particular only if a UE known to it, for example the second UE, is detected. This reduces the energy consumption of the first UE.

In one exemplary embodiment, the network component may be an administrative platform or an additional user terminal. The additional UE may be, for example, a master device which has data keys for authenticating a UE, for example the second UE. In particular, the master device can thus provide the first UE and the second UE with all the information required to simplify or to prevent an initial establishment of a Bluetooth connection. For example, the additional UE can send the Bluetooth encryption data to the first UE and the second UE. Optionally, the additional UE can send information about an identification of the first UE or second UE to the second UE or first UE. This allows the first UE to detect the second UE or the second UE to detect the first UE in a simplified manner.

An administrative platform may be advantageous in particular for the management of a plurality of UEs, for example a plurality of first UEs (for example, multiple vehicles in a car-sharing fleet). For example, the administrative platform can generate Bluetooth encryption data for a first UE of a plurality of UEs for the second UE. This allows the second UE to be granted access to the first UE of the plurality of UEs.

In particular, the Bluetooth encryption data in an application may be limited, for example, to a period of time, a location, a usage behavior, etc. For example, the Bluetooth encryption data can grant a user of the second UE access to a vehicle, for example, a vehicle from a car-sharing fleet, which comprises the first UE. The Bluetooth encryption data can be linked, for example, to a rental period, a location of a rental, a number of possible uses, etc. This can prevent an unwanted use of the first UE by a user of the second UE.

In one exemplary embodiment, the first user terminal can be a vehicle. For example, an owner of the vehicle may possess a master device, such as a smartphone, which comprises at least one data key. The owner can pass this data key on to a user of a second UE so that the second UE can gain access to the vehicle. By the step of generating 120 the Bluetooth encryption data, the master device can then provide the second UE and the first UE with all the necessary parameters for establishing a Bluetooth connection.

In one exemplary embodiment, the Bluetooth encryption data can be generated in the vehicle. In particular, the Bluetooth encryption data can be generated on-board. This means the vehicle can be designed to simplify the establishment of a Bluetooth connection to a UE. Alternatively, the Bluetooth encryption data can be generated off-board, for example by an administrative platform or a UE.

In one exemplary embodiment, the Bluetooth encryption data can comprise information about at least one parameter required for a Bluetooth pairing. This can improve a Bluetooth pairing between the first UE and the second UE. In particular, the first UE and/or the second UE can obtain all the required parameters for Bluetooth pairing from the network component.

In one exemplary embodiment, the method 100 may further comprise a step of encrypting the Bluetooth encryption data for synchronization. This ensures that the Bluetooth encryption data cannot be read by a third party.

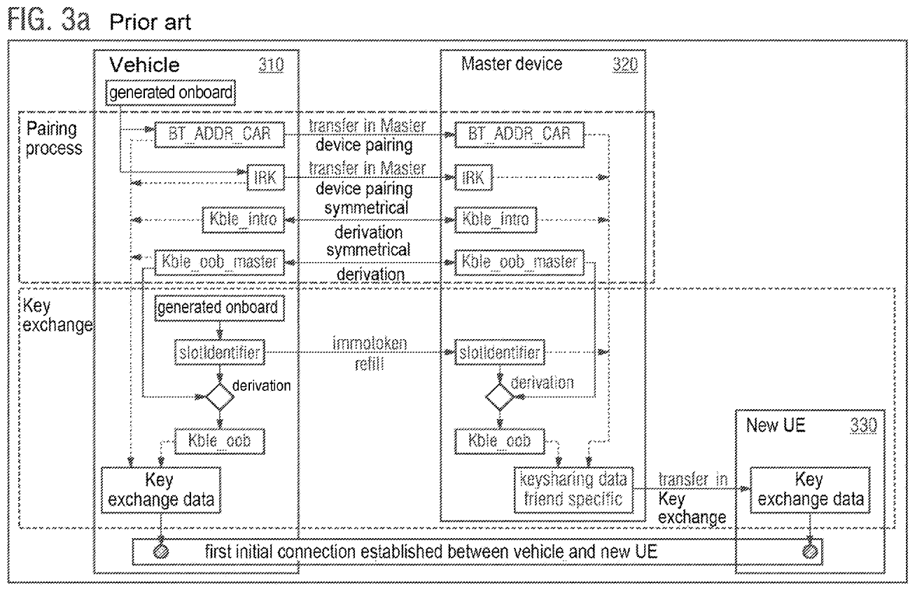

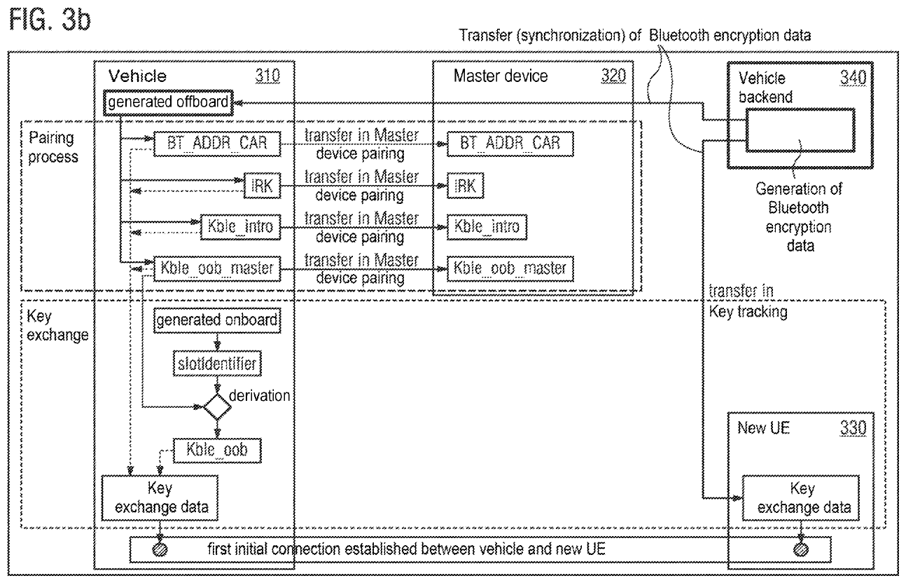

Further details and aspects are mentioned in conjunction with the exemplary embodiments described below. The exemplary embodiment shown in FIG. 1 can have one or more optional additional features corresponding to one or more aspects mentioned in connection with the proposed design or with one or more exemplary embodiments described below (e.g. FIGS. 2-3).

FIG. 2 shows a block diagram of an exemplary embodiment of a device 30 for a network component. In order to provide Bluetooth encryption data, the device 30 comprises one or more interfaces 32 for communicating with a user terminal (for example, the first UE and/or the second UE). The device 30 further comprises a control module 34, which is designed for carrying out at least one of the methods described herein, for example, the method which is described with reference to FIG. 1. Further exemplary embodiments are a vehicle having a device 30.

The one or more interfaces 32 can correspond, for example, to one or more inputs and/or one or more outputs for receiving and/or transmitting information, for example in digital bit values, based on a code, within a module, between modules, or between modules of different entities. The at least one or more interfaces 32 may be designed, for example, to communicate via a (radio) network or a local connection network with other network components.

In exemplary embodiments, the control module 34 can be any kind of controller or processor or a programmable hardware component. For example, the control module 34 can also be implemented as software, which is programmed for a corresponding hardware component. In this respect, the control module 34 can be implemented as programmable hardware with appropriately adapted software. Any type of processors, such as digital signal processors (DSPs), can be used for this. Examplary embodiments are not restricted to a specific type of processor. Any number of processors or even a plurality of processors is conceivable for the implementation of the control module 34.

In at least some exemplary embodiments the vehicle can correspond, for example, to an agricultural vehicle, a water-borne vehicle, an aircraft, a railway vehicle, a road vehicle, a car, a bus, a motorcycle, an all-terrain vehicle, a motor vehicle or a heavy goods vehicle. For example, the control module may be part of a vehicle control unit. The device 30 can also be used in other Bluetooth-enabled electronic devices, such as a Bluetooth speaker, a set of Bluetooth headphones, a smartphone, etc.

Further details and aspects are mentioned in conjunction with the exemplary embodiments described below and/or above. The exemplary embodiment shown in FIG. 2 can comprise one or more optional additional features corresponding to one or more aspects mentioned in connection with the proposed design or with one or more exemplary embodiments described above (e.g. FIG. 1) or below (e.g. FIG. 3).

FIG. 3 shows two schematic diagrams for generating and exchanging Bluetooth encryption data. FIG. 3a shows the prior art. In particular, in FIG. 3a, in the pairing process between a master device and a vehicle a symmetrical generation of required parameters, for example, kble_info and kble_oob_master, takes place. These parameters must then be exchanged between the two UEs 310, 320, i.e. the vehicle 310 and the master device 320. Furthermore, the master device 320 requires further information from the vehicle 310 during the key exchange also, so that the master device 320 can provide all necessary parameters to the new user terminal 330 to be added only after the key exchange between vehicle 310 and master device 320 has completed.

FIG. 3b shows a schematic representation of an example of a method according to the disclosure, for example an exemplary embodiment of a method which has been described with reference to FIG. 1.

FIG. 3b shows the network component 340, which generates the Bluetooth encryption data and synchronizes a vehicle backend 340. The generation of the Bluetooth encryption data can take place by way of the vehicle backend before an initial connection between the vehicle 310 and the new user terminal 330 to be added is attempted, for example before a Bluetooth pairing is carried out. The vehicle backend 340 then sends the generated Bluetooth encryption data to the vehicle 310 and the new user terminal 330 to be added. This allows the new user terminal 330 to be added to connect to the vehicle 310 via Bluetooth without needing to establish a connection first. For example, this can prevent a first unsecured connection before, for example, PAKE has been carried out. The vehicle 310 and the new user terminal 330 to be added can essentially perform a synchronization of the out-of-band information. This allows an initial establishment of a Bluetooth connection to be started directly, in particular after the Bluetooth encryption data has been synchronized. For example, a Bluetooth pairing can be started without the need for further exchange of out-of-band information between the vehicle 310 and the new user terminal 330 to be added.

Optionally, during a Bluetooth pairing between the master device 320 and the vehicle 310, the required Bluetooth encryption data can be sent directly from the vehicle 310 to the master device 320. It may no longer be necessary to generate Bluetooth encryption data by means of the master device 320. In particular, the Bluetooth encryption data can be sent from the vehicle 310 to the master device 320 via a secured connection during the master device pairing. It may also no longer be necessary to transfer information to the master device 320 during key exchange. The master device pairing can be used in particular for teaching the master device 320 to the vehicle 310. The master device pairing can be done, for example, using WPAN, e.g. Bluetooth, WLAN, etc. The master device pairing can be performed, for example, according to CCC standards. For example, the CCC-TS-101 standard Digital Key Technical Specification Release 3, Version 1.0.0, Chapter 6 can be used.

The vehicle backend 340 can generate and synchronize new Bluetooth encryption data, in particular after each receipt of for information generating Bluetooth encryption data for establishing an encrypted Bluetooth connection between a first user terminal and a second user terminal. For example, information obtained may include information about a newly generated/used data key. The newly generated/used data key can be generated in particular via a sharing of access rights, for example by way of the master device 320 and/or a service data key, for example by means of an administrative platform such as the vehicle backend 340. The vehicle backend 340 can then, after obtaining the information and generating the Bluetooth encryption data, send this data to the vehicle 310 and the new user terminal 330 to be added. In particular, the transmission can take place immediately after the generation of the Bluetooth encryption data, or as soon as a connection to the vehicle 310 and/or the new user terminal 330 to be added can be established. This can be carried out, for example, by extending the information sent over a secure connection during tracking of a new user terminal 330 to be added.

For example, a car-sharing fleet manager can create a data key for a customer using an administrative platform. For example, the vehicle backend 340 can be used to replace a master device 320. Thus, in particular, no master device 320 needs to be present. The new user terminal 330 to be added can then obtain the (service) data key from the vehicle backend 340. The (service) data key can be registered with the vehicle backend 340. In addition, the new user terminal 330 to be added can also obtain the Bluetooth encryption data generated from the vehicle backend 340, for example, simultaneously with the (service) data key. The same Bluetooth encryption data can be obtained by the vehicle 310. In addition, the vehicle 310 can also obtain the information about the (service) data key, and/or information that allows identification of the new user terminal 330 to be added. This can then improve an initial connection for a Bluetooth connection.

For example, a user of a master device 320 may want to allow a friend access to his/her vehicle 310. For this purpose, the user can use his/her master device 320 to send a data key to the newly added user terminal 330 belonging to the friend. The data key can then be registered with the vehicle backend 340. In addition, the new user terminal 330 to be added can obtain the Bluetooth encryption data generated by the vehicle backend 340. In this case, the receipt of the data key may be separated from the receipt of the Bluetooth encryption data. Alternatively, the master device 320 can also generate the Bluetooth encryption data. In this case, there may not be a vehicle backend 340 present.

Further details and aspects are mentioned in conjunction with the exemplary embodiments described above. The exemplary embodiment shown in FIG. 3 can have one or more optional additional features corresponding to one or more aspects mentioned in connection with the proposed design or with one or more exemplary embodiments described above (e.g. FIGS. 1-2).

Further exemplary embodiments are computer programs for carrying out any of the methods described herein, when the computer program is executed on a computer, a processor or a programmable hardware component. Depending on the specific implementation requirements, exemplary embodiments of the disclosure can be implemented either in hardware or in software. The implementation can be carried out by using a digital storage medium, such as a floppy disk, a DVD, a Blu-Ray disc, a CD, a ROM, a PROM, or an EPROM, EEPROM or Flash memory, a hard disk or other magnetic or optical storage, on which electronically readable control signals are stored, which can interact with a programmable hardware component, or interact in such a way that the respective method is carried out.

A programmable hardware component can be formed by a processor, a computer processor (CPU=Central Processing Unit), a graphics processing unit (GPU=Graphics Processing Unit), a computer, a computer system, an application-specific integrated circuit (ASIC), an integrated circuit (IC), a single-chip system (SOC=System-on-Chip), a programmable logic element or a field-programmable gate array (FPGA) with a microprocessor.

The digital storage medium can therefore be machine- or computer-readable. Some exemplary embodiments thus comprise a data carrier, which has electronically readable control signals that are capable of interacting with a programmable computer system or a programmable hardware component, in such a way that one of the methods described herein is carried out. One exemplary embodiment therefore is a data carrier (or a digital storage medium or a computer-readable medium), on which the program is recorded for carrying out one of the methods described herein.

In general, exemplary embodiments of the present disclosure can be implemented as software, firmware, computer program or computer program product with a program code or as data, wherein the program code is, or the data are, effective in terms of carrying out one of the methods if the program is running on a processor or a programmable hardware component, or other controller. The program code or the data can also be stored, for example, on a machine-readable medium or data carrier. The program code or the data can exist in the form of source code, machine code or byte code, among other things, as well as other intermediate code.

The examples described above only represent an illustration of the principles of the present disclosure. It is implicit that modifications and variations of the arrangements and details described herein will be apparent to other persons skilled in the art. It is therefore intended that the disclosure be limited only by the scope of protection of the following patent claims and not by the specific details, which have been presented herein on the basis of the description and explanation of the exemplary embodiments.

### LIST OF REFERENCE SIGNS

30 device
32 interface
34 control module
100 method for providing Bluetooth encryption data
110 obtaining information
120 generating the Bluetooth encryption data
130 synchronizing the Bluetooth encryption data
310 vehicle
320 master device
330 new user terminal to be added
340 vehicle backend

1.-10. (canceled)

11. A method for a network component for providing Bluetooth encryption data, the method comprising:
obtaining received information for generating Bluetooth encryption data for establishing an encrypted Bluetooth connection between a first user terminal and a second user terminal based on the received information;
generating the Bluetooth encryption data; and
synchronizing the Bluetooth encryption data between the first user terminal and the second user terminal.

12. The method as claimed in claim 11, wherein the received information comprises an identification for at least the first user device or the second user device.

13. The method as claimed in claim 12, wherein the network component is an administrative platform or another user terminal.

14. The method as claimed in claim 13, wherein the first user terminal is a vehicle.

15. The method as claimed in claim 14, wherein the Bluetooth encryption data is generated in the vehicle.

16. The method as claimed in claim 15, wherein the Bluetooth encryption data comprises information about at least one parameter required for a Bluetooth pairing.

17. The method as claimed in claim 16, further comprising encrypting the Bluetooth encryption data for synchronization.

18. A non-tangible computer readable medium for providing Bluetooth encryption data, wherein the computer-readable medium comprises instructions which, when executed on a controller, causes the controller to:
receive information for generating Bluetooth encryption data for establishing an encrypted Bluetooth connection between a first user terminal and a second user terminal based on the received information;
generate the Bluetooth encryption data; and
synchronize the Bluetooth encryption data between the first user terminal and the second user terminal.

19. The non-tangible computer readable medium as claimed in claim 18, wherein the received information comprises an identification for at least the first user device or the second user device.

20. The non-tangible computer readable medium as claimed in claim 19, wherein the network component is an administrative platform or another user terminal.

21. The non-tangible computer readable medium as claimed in claim 20, wherein the first user terminal is a vehicle.

22. The non-tangible computer readable medium as claimed in claim 21, wherein the Bluetooth encryption data is generated in the vehicle.

23. The non-tangible computer readable medium as claimed in claim 22, wherein the Bluetooth encryption data comprises information about at least one parameter required for a Bluetooth pairing.

24. The non-tangible computer readable medium method as claimed in claim 23, wherein the computer-readable medium further comprises instructions which, when executed on the controller, causes the controller to encrypt the Bluetooth encryption data for synchronization.

25. A vehicle having a network device for providing Bluetooth encryption data, the network device comprising:
one or more interfaces for communication with a user terminal; and
a controller configured to:
receive information for generating Bluetooth encryption data for establishing an encrypted Bluetooth connection between the vehicle and a user terminal based on the received information;
generate the Bluetooth encryption data; and
synchronize the Bluetooth encryption data between the vehicle and the user terminal.

26. The vehicle of claim 25 wherein the received information comprises an identification for the user device.

27. The vehicle of claim 26, wherein the network device is an administrative platform or another user terminal.

28. The vehicle of claim 27, wherein the Bluetooth encryption data is generated in the vehicle.

29. The vehicle of claim 28, wherein the Bluetooth encryption data comprises information about at least one parameter required for a Bluetooth pairing.

30. The vehicle of claim 29, the controller further configured to encrypt the Bluetooth encryption data for synchronization.
